(19) United States
(12) Patent Application Publication
(10) Pub. No.: US 2026/0221911 A1
(43) Pub. Date: Jul. 30, 2026

(54) Motor Control Device and Electric Vehicle

(71) Applicant: Astemo, Ltd., Chiyoda-ku, Tokyo (JP)

(72) Inventors: Shun TANIGUCHI, Tokyo (JP); Kentaro MATSUO, Hitachinaka-shi, Ibaraki (JP); Toshiyuki AJIMA, Tokyo (JP); Satoshi SUMITA, Tokyo (JP)

(21) Appl. No.: 19/146,609

(22) PCT Filed: Mar. 7, 2024
(86) PCT No.: PCT/JP2024/008886

§ 371 Date: Jul. 9, 2025

(30) Foreign Application Priority Data
Mar. 15, 2023 (JP) 2023-040958

(51) Int. Cl. H02P 21/22; B60L 15/20

(52) U.S. Cl. CPC H02P 21/22; B60L 15/20; B60L 2240/421; B60L 2240/423

(57) ABSTRACT

A motor control device includes a current instruction value generation unit that generates a d-axis current instruction value and a q-axis current instruction value, based on a torque instruction value and a rotating speed of a motor, and controls driving of the motor, according to the d-axis current instruction value and the q-axis current instruction value. The current instruction value generation unit includes: a first d-axis current instruction value generation unit that generates a first d-axis current instruction value, based on the torque instruction value and the rotating speed of the motor; an MT d-axis current instruction value generation unit that generates an MT d-axis current instruction value that is a d-axis current instruction value matching a maximum torque per ampere (MTPA), based on the torque instruction value; and a second d-axis current instruction value generation unit that when a voltage-across-terminals of the motor is equal to or lower than a given value, generates a second d-axis current instruction value that causes the first d-axis current instruction value to approach the MT d-axis current instruction value. The current instruction value generation unit generates a third d-axis current instruction value as the d-axis current instruction value, by adding the second d-axis current instruction value to the first d-axis current instruction value.

### TECHNICAL FIELD

The present invention relates to a motor control device and an electric vehicle.

### BACKGROUND ART

A motor control device that converts DC power into AC power by a power converter and drives a motor with AC power has been known. The motor control device needs to perform control so that a voltage-across-terminals of the motor, the voltage increasing with the rotating speed of the motor, does not exceed a maximum output voltage of the power converter. This control is called field-weakening control, by which the voltage-across-terminals of the motor is adjusted through a flow of a current (hereinafter, “field-weakening current”) that cancels interlinkage magnetic flux of the stator of the three-phase synchronous motor.

PTL 1 discloses a device that includes a field-weakening current calculation unit that calculates a field-weakening current value, based on a difference between a maximum voltage value and a motor voltage value, and that determines a trigger for starting field-weakening control and a field-weakening current for performing field-weakening control.

PTL 2 discloses a device including a current instruction correction unit that generates a positive correction amount that is added to a pre-correction d-axis current instruction when a voltage amplitude, which represents a voltage-across-terminals of a motor, is equal to or higher than a given reference voltage; and a voltage feedback control unit that generates a negative correction amount that is added to the pre-correction d-axis current instruction so that the voltage amplitude does not exceed a given maximum output voltage.

### CITATION LIST

### Patent Literature

PTL 1: JP 2006-141095 A
PTL 2: JP 2022-129321 A

### SUMMARY OF INVENTION

### Technical Problem

The devices described in PTL 1 and PTL 2 have difficulty in properly controlling a field-weakening current under a low torque/high temperature condition in which a flow of the field-weakening current is excessively greater than the flow in a normal condition. This results in a drop in the efficiency of the motor.

### Solution to Problem

A motor control device according to the present invention includes a current instruction value generation unit that generates a d-axis current instruction value and a q-axis current instruction value, based on a torque instruction value and a rotating speed of a motor, and controls driving of the motor, according to the d-axis current instruction value and the q-axis current instruction value. The current instruction value generation unit includes: a first d-axis current instruction value generation unit that generates a first d-axis current instruction value, based on the torque instruction value and the rotating speed of the motor; an MT d-axis current instruction value generation unit that generates an MT d-axis current instruction value that is a d-axis current instruction value matching a maximum torque per ampere (MTPA), based on the torque instruction value; and a second d-axis current instruction value generation unit that when a voltage-across-terminals of the motor is equal to or lower than a given value, generates a second d-axis current instruction value that causes the first d-axis current instruction value to approach the MT d-axis current instruction value. The current instruction value generation unit generates a third d-axis current instruction value as the d-axis current instruction value, by adding the second d-axis current instruction value to the first d-axis current instruction value.

### Advantageous Effects of Invention

According to the present invention, the field-weakening current is properly controlled even under the low torque/high temperature condition in which a flow of the field-weakening current is excessively greater than the flow in the normal condition, and therefore a drop in the efficiency of the motor can be prevented.

### BRIEF DESCRIPTION OF DRAWINGS

FIG. 1 is an overall configuration diagram of a motor control device according to a first embodiment.

FIG. 2 is a block configuration diagram of a current instruction value generation unit according to the first embodiment.

FIG. 3 is a block configuration diagram of a second d-axis current instruction value generation unit according to the first embodiment.

FIG. 4 depicts an example in which a first d-axis current instruction value generation unit 81 of the first embodiment is provided as a lookup table.

FIGS. 5(A), 5(B), and 5(C) depict an example of changes in a d-axis current instruction value generated by the current instruction value generation unit.

FIGS. 6(A) and 6(B) depict an example of changes in the d-axis current instruction value in a comparative example.

FIG. 7 is an overall configuration diagram of a motor control device according to a second embodiment.

FIG. 8 is a block configuration diagram of a current instruction value generation unit according to the second embodiment.

FIG. 9 is a block configuration diagram of a second d-axis current instruction value generation unit according to the second embodiment.

FIG. 10 is a configuration diagram of an electric vehicle according to a third embodiment.

### DESCRIPTION OF EMBODIMENTS

Embodiments of the present invention will hereinafter be described with reference to the drawings. The following description and drawings are exemplary one for explanation of the present invention, and, to make the explanation clear, will be omitted or simplified when necessary. The present invention can be implemented in various forms different from embodiments described herein. Unless otherwise specified, each constituent element of a single form and of a plural form are both applicable.

### First Embodiment

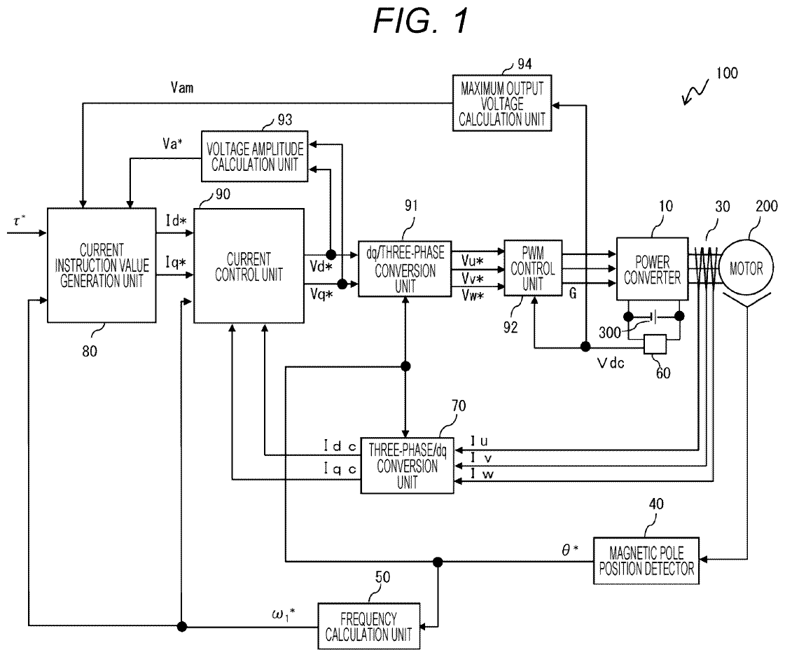

FIG. 1 is an overall configuration diagram of a motor control device 100 according to a first embodiment of the present invention. The motor control device 100 converts DC power into AC power by a power converter 10 and controls driving of a motor 200.

The motor 200 is provided as a permanent magnet synchronous motor (PMSM). However, effects of the present invention are not limited to applications of the permanent magnet synchronous motor but are achieved also in applications of an AC machine, such as a synchronous reluctance motor, a permanent magnet synchronous generator, a winding-type synchronous machine, an induction motor, or an induction generator. It should be noted that the effects of the present invention are particularly remarkable in applications of the permanent magnet synchronous motor and the permanent magnet synchronous generator in which a field-weakening current changes widely depending on temperature. Semiconductor switching elements of the power converter 10, which is an inverter, are provided as IGBTs. The semiconductor switching elements are, however, not limited to IGBTs but may be MOSFETs or other switching elements.

In FIG. 1, the power converter 10 converts DC power from a DC power supply 300 (e.g., a battery), into AC power according to a gate signal G, and sends AC power to the motor 200 to drive it. Current values Iu, Iv, and Iw of currents of three phases, i.e., a U phase, a V phase, and a W phase, the currents flowing from the power converter 10 to the motor 200, are detected by a current detector 30. The current detector 30 is composed of a hall current transformer (CT) or the like.

A magnetic pole position detector 40 is disposed near the motor 200. The magnetic pole position detector 40, which is composed of a resolver or the like, detects a magnetic pole position of the motor 200 and outputs magnetic pole position information θ*.

A frequency calculation unit 50 calculates a rotating speed ω1* from the magnetic pole position information θ* detected by the magnetic pole position detector 40 by, for example, differentiation and outputs the rotating speed ω1*. A voltage detector 60 detects a voltage of the DC power supply 300 and outputs a DC voltage Vdc.

A three-phase/dq conversion unit 70 carries out coordinate transformation of the current values Iu, Iv, Iw of three phases detected by current detector 30, u using the magnetic pole position information θ* detected by the magnetic pole position detector 40, and outputs a d-axis current detection value Idc and a q-axis current detection value Iqc.

To the current instruction value generation unit 80, the torque instruction value τ* from a host control device (not illustrated) and the rotating speed ω1* of the motor 200 from the frequency calculation unit 50 are inputted, and a voltage amplitude Va* from a voltage amplitude calculation unit 93 and a maximum output voltage Vam from a maximum output voltage calculation unit 94 are inputted as well. Based on these pieces of incoming information, the current instruction value generation unit 80 generates a d-axis current instruction value Id* and a q-axis current instruction value Iq*. Details of the current instruction value generation unit 80 will be described later.

A current control unit 90 outputs a d-axis voltage instruction value Vd* and a q-axis voltage instruction value Vq* so that the d-axis current instruction value Id* matches the d-axis current detection value Idc and the q-axis current instruction value Iq* matches the q-axis current detection value Iqc.

Referring to the d-axis voltage instruction value Vd* and the q-axis voltage instruction value Vq* outputted from the current control unit 90, the voltage amplitude calculation unit 93 calculates the voltage amplitude Va* by equation (1) below. The voltage amplitude Va* is a value corresponding to a voltage-across-terminals of the motor 200.

$$\begin{matrix}[ Equation 1 ] & \\ {V}_{a}^{*} = \sqrt{{V}_{d}^{⋆ 2} + {V}_{q}^{* 2}} & ( 1 )\end{matrix}$$

The maximum output voltage calculation unit 94 calculates the maximum output voltage Vam from a DC voltage Vdc. When a sinusoidal modulation method (modulation method according to which the ratio of an output voltage amplitude to the DC voltage Vdc is 0.866 (≈√3/2) at maximum in terms of line voltage) is applied, the maximum output voltage Vam is given by equation (2) below. The maximum output voltage Vam corresponds to a maximum output voltage of the voltage-across-terminals of the motor 200.

$$\begin{matrix}[ Equation 2 ] & \\ {V}_{am} = {V}_{dc} / 2 & ( 2 )\end{matrix}$$

Equation (2) shows an example of calculation according to the sinusoidal modulation method. When an overmodulation method (modulation method by which a voltage higher than a voltage given by the sinusoidal modulation method can be outputted but voltage increased) is applied, the resulting maximum output voltage is, at maximum, about 10% of the maximum output voltage given by equation (2).

A dq/three-phase conversion unit 91 carries out coordinate transformation of the d-axis voltage instruction value Vd* and the q-axis voltage instruction value Vq* outputted from the current control unit 90, using the magnetic pole position information θ* detected by the magnetic pole position detector 40, and outputs voltage instruction values Vu*, Vv*, and Vw* of three phases.

A PWM control unit 92 calculates a duty signal from the voltage instruction values Vu*, Vv*, and Vw* of three phases and the DC voltage Vdc, compares the duty signal with a carrier wave, and outputs the gate signal G to the power converter 10.

In the power converter 10, semiconductor switching elements make up the inverter, and are switched on/off by the gate signal G. As a result, DC power supplied from the DC power supply 300 is converted into AC power, with which the motor 200 is driven to rotate.

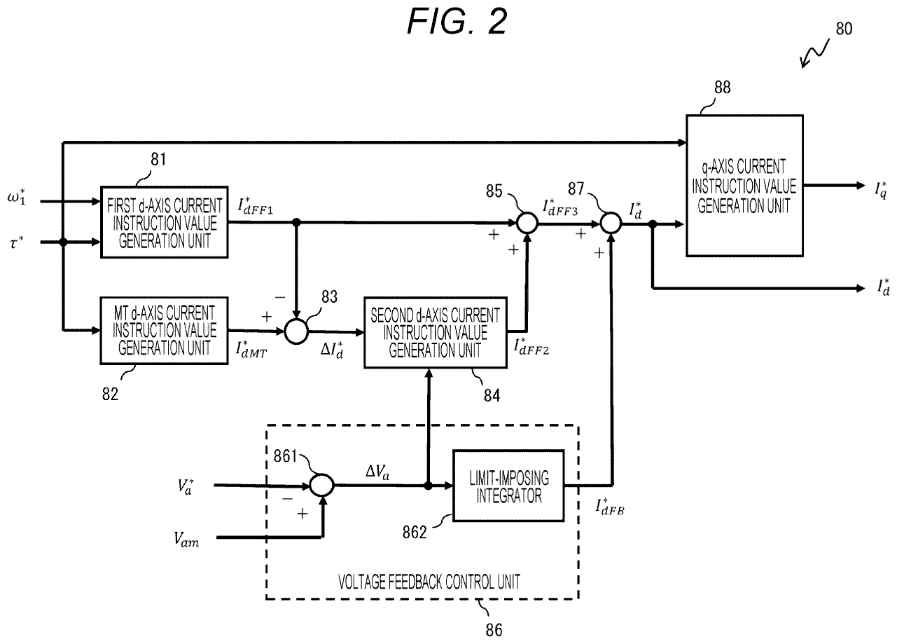

FIG. 2 is a block configuration diagram of the current instruction value generation unit 80.

The current instruction value generation unit 80 includes a first d-axis current instruction value generation unit 81, an MT d-axis current instruction value generation unit 82, a second d-axis current instruction value generation unit 84, a voltage feedback control unit 86, and a q-axis current instruction value generation unit 88.

The first d-axis current instruction value generation unit 81 generates a first d-axis current instruction value IdFF1*, based on the rotating speed ω1* and the torque instruction value τ*. The first d-axis current instruction value generation unit 81 may be provided as, for example, a lookup table or an approximate expression. An example in which the rotating speed ω1* and the torque instruction value τ* are inputted to the first d-axis current instruction value generation unit 81 is shown. However, the DC voltage Vdc may also be inputted, in which case the first d-axis current instruction value generation unit 81 is provided as a lookup table or an approximate expression with three input values. Furthermore, a rotor temperature Tr of the motor 200 may also be inputted, in which case the first d-axis current instruction value generation unit 81 is provided as a lookup table or an approximate expression with four input values. In each of these cases, the first d-axis current instruction value generation unit 81 generates and outputs the first d-axis current instruction value IdFF1* by which a maximum torque per ampere (MTPA) results, in a region where a voltage margin exists, and generates and outputs the first d-axis current instruction value IdFF1* that causes the voltage amplitude Va* and the maximum output voltage Vam to match, in a region where voltage is limited.

The region where the voltage margin exists is, for example, a region where a voltage difference ΔVa with the maximum output voltage Vam is equal to or larger than a given value ΔVa*, and the region where voltage is limited is, for example, a region where the voltage difference ΔVa is less than the given value ΔVa*. In general, the voltage difference ΔVa becomes equal to or larger than the given value ΔVa* under the low torque/high temperature condition. In this embodiment, the current instruction value generation unit 80 corrects the first d-axis current instruction value IdFF1* according to the voltage difference ΔVa and generates the d-axis current instruction value Id* and the q-axis current instruction value Iq*. As a result, a field-weakening current is controlled properly to prevent a drop in the efficiency of the motor.

Based on the torque instruction value τ*, the MT d-axis current instruction value generation unit 82 generates an MT d-axis current instruction value IdMT*, which is a d-axis current instruction value that changes to match the maximum torque per ampere (MTPA). The MT d-axis current instruction value generation unit 82 may be provided as a lookup table or an approximate expression. An example in which the torque instruction value τ* is inputted to the MT d-axis current instruction value generation unit 82 is shown. However, the rotor temperature Tr may also be inputted, in which case the MT d-axis current instruction value generation unit 82 is provided as a lookup table or an approximate expression with two input values.

A subtractor 83 subtracts the first d-axis current instruction value IdFF1* from the MT d-axis current instruction value IdMT* to obtain a d-axis current instruction value difference ΔId*, and outputs the d-axis current instruction value difference ΔId* to the second d-axis current instruction value generation unit 84.

The voltage feedback control unit 86 includes a subtractor 861 and a limit-imposing integrator 862. The subtractor 861 calculates the voltage difference ΔVa between the maximum output voltage Vam and the voltage amplitude Va*, and outputs the voltage difference ΔVa to the second d-axis current instruction value generation unit 84 and to the limit-imposing integrator 862.

The limit-imposing integrator 862 multiplies the voltage difference ΔVa by a cutoff frequency ωfw for field-weakening control, divides the multiplication result by a d-axis inductance Ld and the rotating speed ω1*, and integrates the division result to produce a feedback d-axis current instruction value IdFB*, thus outputting the feedback d-axis current instruction value IdFB*.

The limit-imposing integrator 862 limits the feedback d-axis current instruction value IdFB* to prevent it from becoming positive. Specifically, the limit-imposing integrator 862 has a variation limit value, and when the voltage-across-terminals of the motor 200 is larger than a given value, sets the variation limit value in the positive direction to 0, thereby keeping the feedback d-axis current instruction value IdFB* negative. The variation limit value is a value by which a variation of the first d-axis current instruction value IdFF1* in a case of the voltage-across-terminals of the motor 200 being smaller than the given value is made sufficiently slower than a response of the voltage feedback control unit 86.

In this manner, the voltage feedback control unit 86 generates the feedback d-axis current instruction value IdFB* for correcting a third d-axis current instruction value IdFF3* so that the voltage-across-terminals of the motor 200 does not exceed the given maximum output voltage.

The second d-axis current instruction value generation unit 84 generates a second d-axis instruction value IdFF2* according to the d-axis current instruction value difference ΔId* between the first d-axis current instruction value IdFF1* and the MT d-axis current instruction value IdMT*.

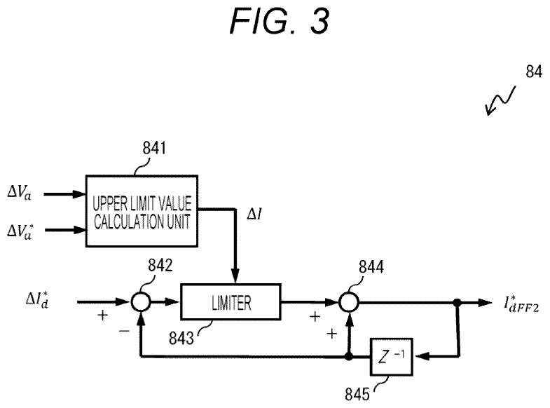

FIG. 3 is a block configuration diagram of the second d-axis current instruction value generation unit 84.

The second d-axis current instruction value generation unit 84 includes an upper limit value calculation unit 841, a subtractor 842, a limiter 843, an adder 844, and a memory 845.

When the voltage difference ΔVa is equal to or larger than a given value ΔVa* equal to or larger than 0, the upper limit value calculation unit 841 calculates an upper limit value ΔI of the d-axis current instruction value difference, using the following equation (3). When the voltage difference ΔVa is smaller than the given value ΔVa* equal to or larger than 0, on the other hand, the upper limit value calculation unit 841 outputs “0”.

$$\begin{matrix}[ Equation 3 ] & \\ Δ I = - {dI}_{d \_ max} * \frac{{ω}_{fw}}{5} * Δ t & ( 3 )\end{matrix}$$

In this equation, dId_max denotes a compensation maximum for the d-axis current instruction value. For example, it represents a compensation quantity required under a maximum temperature. Δt denotes a control calculation cycle. In equation (3), to ensure that control of the upper limit value ΔI of the d-axis current instruction value difference is sufficiently slower than voltage feedback control by the voltage feedback control unit 86, the cutoff frequency ωfw is divided by 5, a divisor, to obtain a gain of ⅕. By setting the divisor larger than 1, control of the upper limit value ΔI can be made slower than voltage feedback control. Furthermore, by setting the divisor larger than 5, control of the upper limit value ΔI can be made sufficiently slower than voltage feedback control, in which case, even if the voltage amplitude Va* exceeds the maximum output voltage Vam because of a change in the second d-axis current instruction value IdFF2*, voltage feedback control comes to work immediately.

The subtractor 842 calculates a difference between the d-axis current instruction value difference ΔId* and a previous value of the second d-axis current instruction value IdFF2*. The limiter 843 sets an upper limit to the difference calculated by the subtractor 842, using the upper limit value ΔI of the d-axis current instruction value difference that the upper limit value calculation unit 841 obtains. The adder 844 adds output from the limiter 843 to the previous value of the second d-axis current instruction value IdFF2*, and outputs the second d-axis current instruction value IdFF2*. The memory 845 holds the second d-axis current instruction value IdFF2*, and outputs this second d-axis current instruction value IdFF2* to the subtractor 846 and the adder 844, as a previous value of the second d-axis current instruction value IdFF2*.

In this configuration, the second d-axis current instruction value generation unit 84 adds the d-axis current instruction value difference ΔId* limited by the upper limit value ΔI of the d-axis current instruction value difference, to the previous value of the second d-axis current instruction value IdFF2*, and outputs the addition result as the second d-axis current instruction value IdFF2*.

In this manner, when the voltage-across-terminals of the motor 200 is larger than the given value, the second d-axis current instruction value generation unit 84 holds the second d-axis current instruction value IdFF2* in such a way as to prevent it from increasing. When the voltage-across-terminals of the motor 200 is equal to or smaller than the given value, the second d-axis current instruction value generation unit 84 generates the second d-axis current instruction value IdFF2* so that the second d-axis current instruction value IdFF2* changes to match the d-axis current instruction value difference ΔId* between the first d-axis current instruction value IdFF1* and the MT d-axis current instruction value IdMT*.

Now the current instruction value generation unit 80 of FIG. 2 will be described again. An adder 85 adds up the first d-axis current instruction value IdFF1* and the second d-axis current instruction value IdFF2* to generate the third d-axis current instruction value IdFF3*. An adder 87 adds up the third d-axis current instruction value IdFF3* and the feedback d-axis current instruction value IdFB* to generate the d-axis current instruction value Id*. In other words, to prevent the voltage-across-terminals of the motor 200 from exceeding the given maximum output voltage, the third d-axis current instruction value IdFF3* is corrected into the d-axis current instruction value Id*, by the feedback d-axis current instruction value IdFB*.

Based on the torque instruction value τ* and the d-axis current instruction value Id*, the q-axis current instruction value generation unit 88 generates the q-axis current instruction value Iq*, using, for example, a lookup table or an equation.

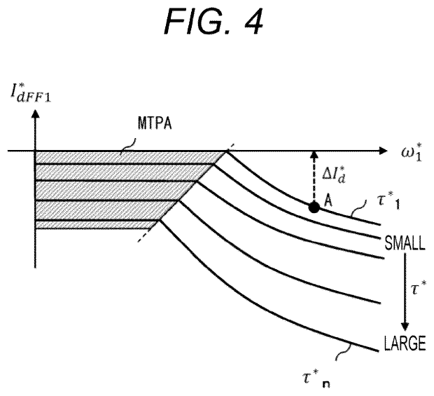

FIG. 4 depicts an example in which the first d-axis current instruction value generation unit 81 is provided as a lookup table.

As shown in FIG. 4, the lookup table has a horizontal axis representing the rotating speed ω1* and a vertical axis representing the first d-axis current instruction value IdFF1*. The torque instruction value τ* is plotted on the table as graphic curves drawn according to respective sizes of the torque instruction value τ*. Now attention is paid to a specific curve representing the torque instruction value τ*. In this curve, the first d-axis current instruction value IdFF1* remains constant until the rotating speed ω1* exceeds a specific value, and after the rotating speed ω1* exceeds the specific value, the first d-axis current instruction value IdFF1* increases in the negative direction as the rotating speed ω1* increases. When the torque instruction value τ* increases, a graphic curve of the torque instruction value τ* shifting in the negative direction results, in which curve the first d-axis current instruction value IdFF1* increases in the negative direction.

In specific curves representing the torque instruction value τ*, a hatched area where the first d-axis current instruction value IdFF1* remains constant until the rotating speed ω1* exceeds the specific value is defined, as shown in FIG. 4. This area represents the d-axis current instruction value that changes to match the maximum torque per aperture (MTPA). The MT d-axis current instruction value generation unit 82 receives input of the torque instruction value τ*, and outputs the MT d-axis current instruction value IdMT* equivalent to IdFF1* outputted when the rotating speed ω1* is 0.

The subtractor 83 of the current instruction value generation unit 80 of FIG. 2 subtracts the first d-axis current instruction value IdFF1* from the MT d-axis current instruction value IdMT* to obtain the d-axis current instruction value difference ΔId*, and outputs the d-axis current instruction value difference ΔId* to the second d-axis current instruction value generation unit 84. This d-axis current instruction value difference ΔId* is, for example, ΔId* at a point A on a curve of the torque instruction value τ1* shown in FIG. 4.

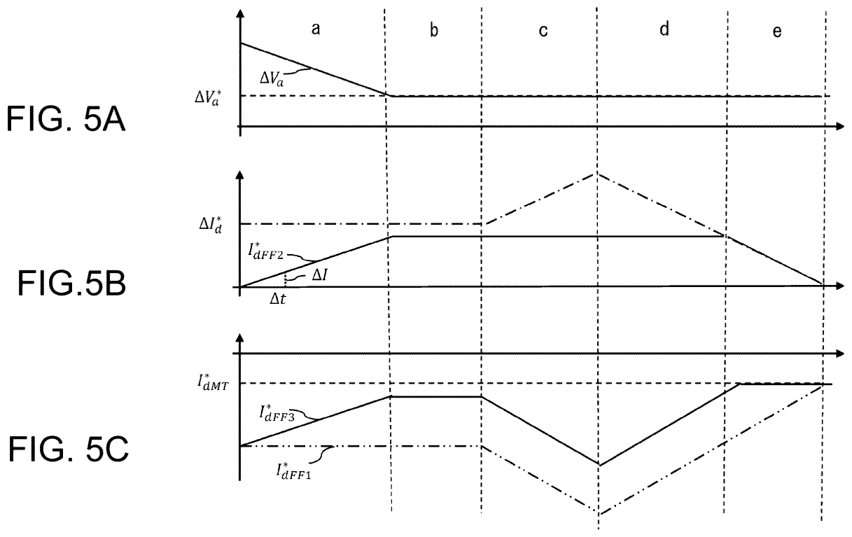

FIGS. 5(A), 5(B), and 5(C) depict an example of changes in the d-axis current instruction value generated by the current instruction value generation unit 80. FIG. 5(A) shows changes in the voltage difference ΔVa with respect to the given value ΔVa*, FIG. 5(B) shows changes in the d-axis current instruction value difference ΔId* and the second d-axis current instruction value IdFF2*, and FIG. 5(C) shows changes in the MT d-axis current instruction value IdMT*, the first d-axis current instruction value IdFF1*, and the third d-axis current instruction value IdFF3*. In each of FIGS. 5(A), 5(B), and 5(C), the horizontal axis represents the same passage of time. For convenience in description, this passage of time is divided into a section a to a section e in time-sequence order.

In the section a, as shown in FIG. 5(A), the voltage difference ΔVa is equal to or larger than the given value ΔVa* equal to or larger than 0. In this section a, as shown in FIG. 5(C), the first d-axis current instruction value IdFF1* and the MT d-axis current instruction value IdMT* remain constant Therefore, as shown in FIG. 5 (B), the d-axis current instruction value difference ΔId* remains constant, too. The second d-axis current instruction value generation unit 84 adds the d-axis current instruction value difference ΔId* to the previous value of the second d-axis current instruction value IdFF2* to generate the second d-axis current instruction value IdFF2*, as shown in FIG. 5 (B). As a result, as shown in FIG. 5(C), the third d-axis current instruction value IdFF3* approaches the MT d-axis current instruction value IdMT*. It should be noted, however, that a rage of change in one control calculation cycle Δt is ΔI given by equation (3).

In the section b to the section e, as shown in FIG. 5(A), the voltage difference ΔVa is smaller than the given value ΔVa* equal to or larger than 0.

In the section b, the first d-axis current instruction value IdFF1* and the MT d-axis current instruction value IdMT* remain constant, as shown in FIG. 5(C), and the d-axis current instruction value difference ΔId* remains constant, too, as shown in FIG. 5(B). However, because the upper limit value ΔI of the d-axis current instruction value difference ΔId* is limited by 0, the second d-axis current instruction value generation unit 84 holds the previous value of the second d-axis current instruction value IdFF2* and generates the second d-axis current instruction value IdFF2*, as shown in FIG. 5(B). As a result, as shown in FIG. 5(C), the third d-axis current instruction value IdFF3* is held as a value closer to the MT d-axis current instruction value IdMT*.

In the section c, for example, when the rotating speed ω1* of the motor 200 increases to cause the first d-axis current instruction value IdFF1* to increase in the negative direction, as shown in FIG. 5(C), the d-axis current instruction value difference ΔId* too increases, as shown in FIG. 5 (B). However, because the upper limit value ΔI is limited by 0, the second d-axis current instruction value generation unit 84 holds the previous value of the second d-axis current instruction value IdFF2* and generates the second d-axis current instruction value IdFF2*, as shown in FIG. 5(B). As a result, as shown in FIG. 5(C), the third d-axis current instruction value IdFF3* increases in the negative direction as the first d-axis current instruction value IdFF1* increases in the negative direction.

In the section d, for example, when the first d-axis current instruction value IdFF1* changes in the positive direction, as illustrated in FIG. 5 (C), the d-axis current instruction value difference ΔId* decreases, as shown in FIG. 5(B). However, because the upper limit value ΔI is limited by 0, the second d-axis current instruction value generation unit 84 holds the previous value of the second d-axis current instruction value IdFF2* and generates the second d-axis current command value IdFF2*, as shown in FIG. 5(B). As a result, as shown in FIG. 5(C), the third d-axis current instruction value IdFF3* changes in the positive direction as the first d-axis current instruction value IdFF1* changes in the positive direction.

In the section e, when the first d-axis current instruction value IdFF1* further changes in the positive direction, as shown in FIG. 5(C), the d-axis current instruction value difference ΔId* decreases, as shown in FIG. 5(B). When the d-axis current instruction value difference ΔId* decreases and consequently the second d-axis current instruction value IdFF2* becomes larger than the d-axis current instruction value difference ΔId*, the second d-axis current instruction value IdFF2* changes to match the d-axis current instruction value difference ΔId*. As a result, as shown in FIG. 5(C), the third d-axis current instruction value IdFF3* is held as a value closer to the MT d-axis current instruction value IdMT*.

As described above, when the voltage difference ΔVa is equal to or larger than the given value ΔVa* equal to or larger than or 0, that is, when the voltage-across-terminals of the motor 200 is equal to or smaller than the given value, the second d-axis current instruction value IdFF2* gradually increases toward the MT d-axis current instruction value IdMT* in the section a. When the voltage difference ΔVa is smaller than the given value ΔVa* equal to or larger than or 0, that is, when the voltage-across-terminals of the motor 200 is larger than the given value, the second d-axis current instruction value IdFF2* is held constant in the section b to the section e. Therefore, for example, when an excessive flow of a field-weakening current under a high-temperature condition results in a decrease in the voltage amplitude Va*, the second d-axis current instruction value IdFF2* increases, which increases the voltage amplitude Va*, thus decreasing the d-axis current.

As a result, even under a low torque/high temperature condition in which a flow of the field-weakening current is excessively greater than the flow in the normal condition, an excessive flow of the field-weakening current is suppressed to properly control the field-weakening current, and therefore an increase in the amount of heat generated by the motor 200 is suppressed to prevent a drop in the efficiency of the motor 200.

In a usual situation, if a current instruction value to be added at execution of voltage feedback control is set too large, for example, when the rotating speed ω1* of the motor suddenly changes, the voltage-across-terminals increases transiently and stays at the maximum value of the output voltage, which develops into a state where any control is useless. Under the low torque/high temperature condition, on the other hand, a flow of the field-weakening current is excessively greater than the flow in the normal condition, in which case the current instruction value to be added needs to be a larger value. For this reason, in a usual situation, lowering a continuous rating is necessary from the viewpoint of dealing with the increasing heat of the motor. Besides, a drop in the motor efficiency leads to a lower electricity mileage. In this embodiment, however, the continuous rating and the electricity mileage can be improved.

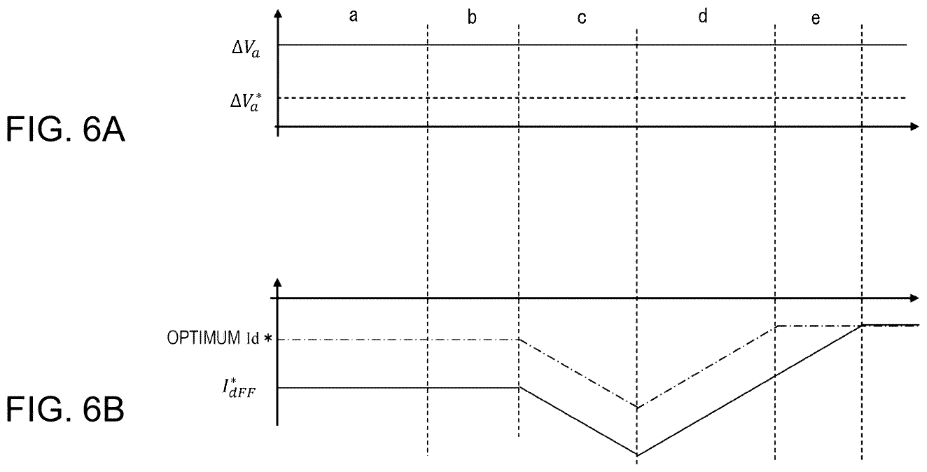

FIGS. 6(A) and 6(B) depict an example of changes in the d-axis current instruction value in a comparative example. This comparative example is a case where this embodiment is not applied.

FIG. 6(A) shows changes in the voltage difference ΔVa with respect to the given value ΔVa*, and FIG. 6(B) shows changes in the d-axis current instruction value IdFF*. In each of FIGS. 5(A), 5(B), and 5(C), the horizontal axis represents the same passage of time. For convenience in description, this passage of time is divided into a section a to a section e in time-sequence order.

In the section a and the section b, even in a state where the voltage difference ΔVa is larger than the given value ΔVa* and therefore a voltage margin exists, as shown in FIG. 6(A), the d-axis current instruction value IdFF* does not change, leaving the field-weakening current excessive, as shown in FIG. 6(B).

Now the rotating speed ω1* increases in the section c and decreases in the section d, and the d-axis current instruction value IdFF* changes in these sections. Still, the voltage difference ΔVa remains large enough to provide a voltage margin, and the d-axis current instruction value IdFF*, which changes to match the field-weakening current, is larger than an optimum instruction value Id*, which leaves the field-weakening current excessive.

In FIG. 2, the example in which the voltage difference ΔVa is inputted to the second d-axis current instruction value generation unit 84 to set the upper limit value ΔI has been described. In a different example, the maximum output voltage Vam and the voltage amplitude Va* may be inputted to the second d-axis current instruction value generation unit 84 and the second d-axis current instruction value generation unit 84 may compare the maximum output voltage Vam with the voltage amplitude Va* to set the upper limit value ΔI. As shown in equation (3), the upper limit value ΔI is determined based on the compensation maximum Id max and the cutoff frequency ωfw of the d-axis current instruction value. The upper limit value ΔI, however, may be set variable by adding a shift from the given value ΔVa* to the upper limit value ΔI. If the given value ΔVa* is set to 0, the field-weakening current can be reduced to the limit. Nevertheless, the field-weakening current can be reduced without setting the given value ΔVa* to 0.

### Second Embodiment

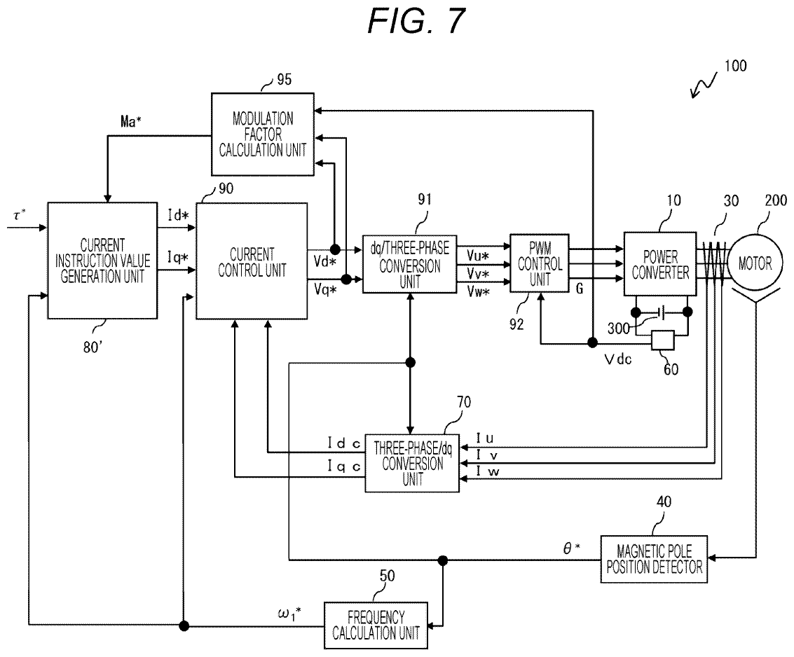

FIG. 7 is an overall configuration diagram of a motor control device 100 according to a second embodiment of the present invention. The motor control device 100 according to the first embodiment includes the voltage amplitude calculation unit 93 and the maximum output voltage calculation unit 94. The motor control device 100 according to the second embodiment, on the other hand, includes a modulation factor calculation unit 95 in place of the voltage amplitude calculation unit 93 and the maximum output voltage calculation unit 94. Other constituent elements of the second embodiment are the same as those of the first embodiment, and therefore the same constituent elements are denoted by the same reference signs and are described briefly.

The modulation factor calculation unit 95 refers to the d-axis voltage instruction value Vd* and q-axis voltage instruction value Vq* outputted from the current control unit 90 and to the DC voltage Vdc, calculates a modulation factor Ma* by equation (4) below, and outputs the modulation factor Ma* to a current instruction value generation unit 80′. FIG. 7 shows a case where the sinusoidal modulation method (modulation method according to which a ratio of an output voltage amplitude to the DC voltage Vdc is 0.866 (≈√3/2) at maximum in terms of a line voltage) is applied.

$$\begin{matrix}[ Equation 4 ] & \\ {M}_{a}^{*} = \frac{2 \sqrt{{V}_{d}^{* 2} + {V}_{q}^{* 2}}}{{V}_{dc}} & ( 4 )\end{matrix}$$

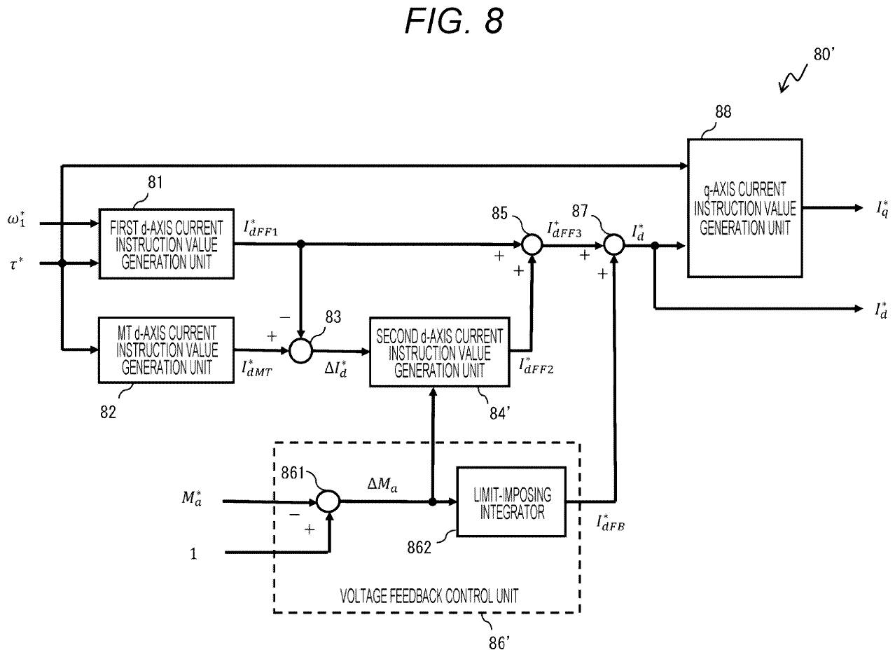

FIG. 8 is a block configuration diagram of the current instruction value generation unit 80′. The same constituent elements as those of the current instruction value generation unit 80 of the first embodiment shown in FIG. 2 are denoted by the same reference signs and are described briefly.

As shown in FIG. 8, 1 and the modulation factor Ma* are inputted to a voltage feedback control unit 86′ of the current instruction value generation unit 80′. The subtractor 861 calculates a difference ΔMa between 1 and the modulation factor Ma*, and outputs the difference ΔMa to the second d-axis current instruction value generation unit 84′ and the limit-imposing integrator 862. The limit-imposing integrator 862 multiplies the modulation factor difference ΔMa by the cutoff frequency ωfw, divides the multiplication result by the d-axis inductance Ld and the rotating speed ω1*, multiplies the division result by the DC voltage Vdc/2, and integrates the multiplication result to output the feedback d-axis current instruction value IdFB*.

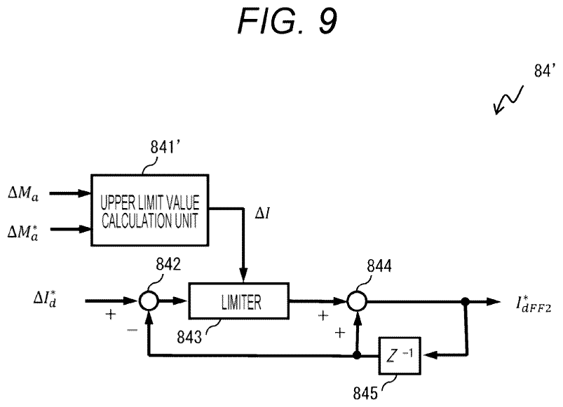

FIG. 9 is a block configuration diagram of the second d-axis current instruction value generation unit 84′. The same constituent elements as those of the second d-axis current instruction value generation unit 84 of the first embodiment shown in FIG. 3 are denoted by the same reference signs and are described briefly.

When the modulation factor difference ΔMa is equal to or larger than a given value ΔMa* equal to or larger than 0, an upper limit value calculation unit 841′ calculates the upper limit value ΔI of the d-axis current instruction value difference, using equation (3). When the modulation factor difference ΔMa is smaller than the given value ΔMa* equal to or larger than 0, on the other hand, the upper limit value calculation unit 841′ outputs “0”.

When the modulation factor difference ΔMa is equal to or larger than the given value ΔMa* equal to or larger than or 0, that is, when the voltage-across-terminals of the motor 200 is equal to or smaller than the given value, the second d-axis current instruction value IdFF2* gradually increases toward the MT d-axis current instruction value IdMT* in the section a of FIG. 5. When the modulation factor difference ΔMa is smaller than the given value ΔMa* equal to or larger than or 0, that is, when the voltage-across-terminals of the motor 200 is larger than the given value, the second d-axis current instruction value IdFF2* is held constant in the section b to the section e of FIG. 5. Therefore, for example, when an excessive flow of a field-weakening current under a high-temperature condition results in a decrease in the voltage amplitude Va*, the second d-axis current instruction value IdFF2* increases, which increases the voltage amplitude Va*, thus decreasing the d-axis current.

According to this embodiment, the same effects as described in the first embodiment are achieved.

### Third Embodiment

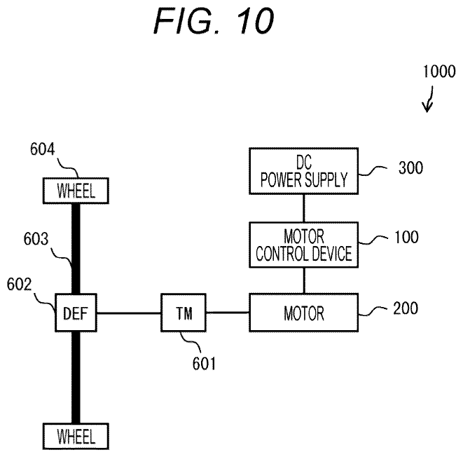

FIG. 10 is a configuration diagram of an electric vehicle 1000 according to a third embodiment.

The electric vehicle 1000 includes the motor 200 controlled by the motor control device 100 described in the first embodiment or the second embodiment, and uses the motor 200 as a driving source.

The motor control device 100 converts DC power from the DC power supply 300 into AC power and drives the motor 3 with DC power. The motor 200 is connected to a transmission 601. The transmission 601 is connected to a drive shaft 603 via a differential gear 602, thus supplying power to a wheel 604. It should be noted that a configuration in which no transmission 601 is provided and the motor 200 is directly connected to the differential gear 602 or a configuration in which the motor 200 and the motor control device 100 are attached to each of front wheels and rear wheels may also be adopted.

In automobile-related applications, a temperature service range is wide and a region where field-weakening control is required is wide as well. In the automobile-related applications, therefore, the effects described in the first and second embodiments become more notable than in other applications. In railway-related applications, as in the automobile-related applications, a temperature service range is wide and a region where field-weakening control is required is wide as well, and therefore the effects described in the first and second embodiments become more notable in the railway-related applications. Hence, in the case of electric vehicle 1000, which is an automobile or a railway car, the continuous rating under a high-temperature condition can be improved and miniaturization of the motor 200 is possible as well.

In the first and second embodiments, the motor control device 100 has been described as the device composed of a plurality of block units. Any intended block unit except the power converter 10, however, may be configured by a computer including a CPU and a memory. In such a case, the computer carries out the above-described processes by executing programs stored in the memory or the like. All or some of processes by the plurality of block units may be implemented by a hard logic circuit. A program may be stored in a storage medium in advance and provided when necessary. A program may be provided through a network line. A program may also be provided as a computer-readable program that generate various forms of signals, such as data signals.

The embodiments described above offers the following effects.

(1) The motor control device 100 according to the present invention includes the current instruction value generation unit 80 (80′) that generates the d-axis current instruction value and the q-axis current instruction value, based on the torque instruction value τ* and the rotating speed ω1* of the motor 200, and controls driving of the motor 200, according to the d-axis current instruction value and the q-axis current instruction value. The current instruction value generation unit 80 (80′) includes: the first d-axis current instruction value generation unit 81 that generates the first d-axis current instruction value IdFF1*, based on the torque instruction value τ* and the rotating speed ω1* of the motor 200; the MT d-axis current instruction value generation unit 82 that generates the MT d-axis current instruction value IdMT* that is the d-axis current instruction value matching the maximum torque per ampere (MTPA), based on the torque instruction value τ*; and the second d-axis current instruction value generation unit 84 (84′) that when the voltage-across-terminals of the motor 200 is equal to or lower than the given value, generates the second d-axis current instruction value IdFF2* that causes the first d-axis current instruction value IdFF1* to approach the MT d-axis current instruction value IdMT*. The current instruction value generation unit 80 (80′) generates the third d-axis current instruction value IdFF3* as the d-axis current instruction value, by adding the second d-axis current instruction value IdFF2* to the first d-axis current instruction value IdFF1*. As a result, even under a low torque/high temperature condition in which a flow of the field-weakening current is excessively greater than the flow in the normal condition, the field-weakening current is properly controlled to prevent a drop in the efficiency of the motor.

The present invention is not limited to the above embodiments. Other embodiments that can be conceived within a range of the technical concept of the present invention are also included in the scope of the invention, providing that such embodiments do not impair features of the present invention. A combination of each of the above embodiments and a modification may also be included in the scope of the invention.

### REFERENCE SIGNS LIST

10 power converter
30 current detector
40 magnetic pole position detector
50 frequency calculation unit
60 voltage detector
70 three-phase/dq conversion unit
80, 80′ current instruction value generation unit
81 first d-axis current instruction value generation unit
82 MT d-axis current instruction value generation unit
84, 84′ second d-axis current instruction value generation unit
86, 86′ voltage feedback control unit
88 q-axis current instruction value generation unit
90 current control unit
91 dq/three-phase conversion unit
92 PWM control unit
93 voltage amplitude calculation unit
94 maximum output voltage calculation unit
95 modulation factor calculation unit
100 motor control device
200 motor
300 DC power supply
841, 841′ upper limit value calculation unit
842 subtractor
843 limiter
844 adder
845 memory
862 limit-imposing integrator
τ* torque instruction value
ω1* rotating speed
IdFF1* first d-axis current instruction value
IdFF2* second d-axis current instruction value
IdFF3* third d-axis current instruction value
IdMT* MT d-axis current instruction value
IdFB* feedback d-axis current instruction value
ΔId* d-axis current instruction value difference
ΔVa* given value

1. A motor control device including a current instruction value generation unit that generates a d-axis current instruction value and a q-axis current instruction value, based on a torque instruction value and a rotating speed of a motor, the motor control device controlling driving of the motor, according to the d-axis current instruction value and the q-axis current instruction value, wherein
the current instruction value generation unit includes:
a first d-axis current instruction value generation unit that generates a first d-axis current instruction value, based on the torque instruction value and the rotating speed of the motor;
an MT d-axis current instruction value generation unit that generates an MT d-axis current instruction value that is a d-axis current instruction value matching a maximum torque per ampere (MTPA), based on the torque instruction value; and
a second d-axis current instruction value generation unit that when a voltage-across-terminals of the motor is equal to or lower than a given value, generates a second d-axis current instruction value that causes the first d-axis current instruction value to approach the MT d-axis current instruction value, and
the current instruction value generation unit generates a third d-axis current instruction value as the d-axis current instruction value, by adding the second d-axis current instruction value to the first d-axis current instruction value.

2. The motor control device according to claim 1, wherein
the current instruction value generation unit includes a voltage feedback control unit that generates a feedback d-axis current instruction value for correcting the third d-axis current instruction value so that the voltage-across-terminals of the motor does not exceed a given maximum output voltage, and
the current instruction value generation unit corrects the third d-axis current instruction value, based on the feedback d-axis current instruction value, and generates the corrected third d-axis current instruction value as the d-axis current instruction value.

3. The motor control device according to claim 1, wherein
the second d-axis current instruction value generation unit generates the second d-axis current instruction value, according to a difference between the first d-axis current instruction value and the MT d-axis current instruction value.

4. The motor control device according to claim 1, wherein
when the voltage-across-terminals of the motor is larger than a given value, the second d-axis current instruction value generation unit holds the second d-axis current instruction value in such a way as to prevent the second d-axis current instruction value from increasing, and
when the voltage-across-terminals of the motor is equal to or smaller than a given value, the second d-axis current instruction value generation unit generates the second d-axis current instruction value so that the second d-axis current instruction value changes to match a difference between the first d-axis current instruction value and the MT d-axis current instruction value.

5. The motor control device according to claim 2, wherein
based on the voltage-across-terminals of the motor and a given maximum output voltage, the voltage feedback control unit generates the feedback d-axis current instruction value so that the voltage-across-terminals of the motor does not exceed the given maximum output voltage.

6. The motor control device according to claim 2, wherein
based on a modulation factor, the voltage feedback control unit generates the feedback d-axis current instruction value so that the voltage-across-terminals of the motor does not exceed a given maximum output voltage.

7. The motor control device according to claim 2, wherein
the voltage feedback control unit includes a limit-imposing integrator having a variation limit value, and when the voltage-across-terminals the motor is larger than a given value, holds the feedback d-axis current instruction value by setting the variation limit value in a positive direction to zero.

8. The motor control device according to claim 7, wherein
the variation limit value of the voltage feedback control unit is a value with which a variation of the first d-axis current instruction value in a case of the voltage-across-terminals of the motor being smaller than a given value is sufficiently slower than a response of the voltage feedback control unit.

9. An electric vehicle comprising:
the motor control device according to claim 1; and
a motor controlled by the motor control device, wherein
the electric vehicle uses the motor as a driving source.
